(19) United States
(12) Patent Application Publication
(10) Pub. No.: US 2026/0019979 A1
(43) Pub. Date: Jan. 15, 2026

(54) METHODS, DEVICES AND SYSTEMS THAT INCLUDE STATISTICAL MODEL FOR TRANSMITTING WAKE-UP MESSAGE TO TARGET DEVICE

(71) Applicant: Cypress Semiconductor Corporation, San Jose, CA (US)

(72) Inventors: Ajinder Pal SINGH, Allen, TX (US); Daniel LEE, Salt Lake City, UT (US); Oleksandr KARPIN, Lviv (UA); Claudio REY, Chandler, AZ (US); Kiran ULN, Pleasanton, CA (US)

(73) Assignee: Cypress Semiconductor Corporation, San Jose, CA (US)

(21) Appl. No.: 18/767,969

(22) Filed: Jul. 9, 2024

(51) Int. Cl. H04W 64/00; H04B 17/318; H04W 52/02

(52) U.S. Cl. CPC H04W 64/00; H04B 17/318; H04W 52/0235

(57) ABSTRACT

A method can include, by operation of controller circuits, determining a higher interference resistance (HIR) location coordinate (PIN) for a route between the wireless device and a target location. A wake message can be transmitted according to a first wireless protocol. In response to receiving an awake message according to a second wireless protocol, a location and quality value for the awake message can be stored. In response to being within a predetermined proximity of the HIR activation PIN without having received the awake message, a HIR wake message can be transmitted. In response to acquiring stored location and quality values, an HIR activation PIN can be selectively changed. A first wireless protocol can consume less power or be less resistant to interference than a second wireless protocol. Corresponding devices and systems are also disclosed.

### TECHNICAL FIELD

The present disclosure relates generally to wireless systems, and more particularly systems in which a wireless device can transmit to one or more target device to wake the target devices from a lower power mode sleep mode to an active mode where data transmissions can occur.

### BACKGROUND

For many wireless devices, such as Internet-of-Things (IoT) devices, low power consumption can be a greatly valued feature, as such devices typically operate on a limited power supply (e.g., battery). To conserve power, wireless devices can include a low power consumption (e.g., sleep) mode, in which some device capabilities can be restricted, and a higher power consumption (e.g., awake) mode, in which all device capabilities are available. Various conventional approaches to waking a sleep device are known.

Synchronous wake-up systems can include devices which can wake-up according to an onboard on/off timer. A drawback to such an approach can be incompatibility with “on-demand” type applications. That is, a user may have to wait during the off period until the device cycles to an on period, and then goes through the transition from sleep mode to wake mode.

Asynchronous wake-up systems can include devices that can transition from a sleep mode to a wake mode according to an onboard trigger, which can be activated by sensors or a human-machine interface. Such systems can also be incompatible with “on-demand” type applications, as time is required to emerge from the sleep mode to wake mode. That is, after triggering the device to wake, a user may still have to wait while the device configures itself for the wake mode.

Polling/advertising type systems, such as Bluetooth Low Energy (BLE), can periodically wake from a sleep mode to issue a message (e.g., advertisement) to indicate their presence and capabilities and await responses. However, such systems may still be incompatible with “on-demand” type applications. If another device manages to connect during the wake time, an on-demand requirement may be met. However, if a wake frequency is increased to improve the probability of connection, more power is consumed. A lower wake frequency decreases the probability of immediately connecting.

More complex systems are known that include complex data recovery stages using a two-dimensional filter based on detected power (e.g., RSSI range) and a length of wake-up word transmitted by an approaching device. However, such stages can rely on complex base band circuits operating at a high frequency clock, adding to cost and power consumption.

It would be desirable to arrive at some way of providing on-demand response in wireless device system.

### SUMMARY

A method can include, by operation of controller circuits, determining a plurality of location coordinates (PINs) for a route between the wireless device and a target location, the PINs including a higher interference resistant (HIR) activation PIN. A wake message can be transmitted according to a first wireless protocol. In response to receiving an awake message according to a second wireless protocol, a location and quality value for the awake message can be stored. In response to being within a predetermined proximity of the HIR activation PIN without having received the awake message, a HIR wake message can be transmitted. In response to acquiring a plurality of stored location values and corresponding quality values over time, an HIR activation PIN can be selectively changed A first wireless protocol can consume less power or be less resistant to interference than the second wireless protocol.

### BRIEF DESCRIPTION OF DRAWINGS

FIGS. 1-0, 1-1, 1-2, 1-3, 1-4 and 1-5 are diagrams showing a system and operations according to an embodiment.

FIGS. 2-0 and 2-1 are diagrams showing systems and operations according to another embodiment.

FIG. 3 is a flow diagram showing wireless device operations according to an embodiment.

FIG. 4 is a flow diagram showing a calibration method according to an embodiment.

FIG. 5 is a graph showing a location adjustment operation according to an embodiment.

FIGS. 6-0, 6-1 and 6-2 are diagrams showing variation in location errors according to embodiments.

FIG. 7 is a block diagram of a wireless device according to an embodiment.

FIG. 8 is a diagram of a wireless device according to another embodiment.

FIG. 9 is a block diagram of a wireless device according to a further embodiment.

FIGS. 10-0 and 10-1 are diagrams of wireless messages according to embodiments.

FIG. 11 is a flow diagram of a method according to an embodiment.

FIGS. 12-0 and 12-1 are flow diagrams of methods according to further embodiments.

FIG. 13 is a block diagram of a target device according to an embodiment.

FIG. 14 is a diagram of a target device according to another embodiment.

FIG. 15 is a flow diagram of a method according to another embodiment.

FIGS. 16-0 and 16-1 are diagrams showing a system and operations according to another embodiment.

FIGS. 17-0 and 17-1 are diagrams showing a system and operations according to a further embodiment.

FIG. 18 is a diagram of a system according to another embodiment.

FIG. 19 is a diagram of a system according to a further embodiment.

### DETAILED DESCRIPTION

According to embodiments, a wireless device can operate in an environment having route to a target device having a lower power consumption (sleep) mode and fully operational (wake) mode. Using location (e.g., Global Positioning System, GPS) circuits, a wireless device can determine a number of locations (referred to herein as PINs) along the route based on a location error for the wireless device. Initially, one of the PINs can be designated a higher interference resistance (HIR) activation PIN. As a distance between a wireless device and target device decreases, the wireless device can transmit messages according to a first protocol. At the same time, the target device can be in a low power consumption (sleep) mode listening for messages according to the first protocol and well as a second protocol. A first protocol can consume less power or be less resistance to interference than the second protocol.

If a target device receives a wake message according to a first protocol or a wake message according to the second protocol, the target device can start transitioning from the sleep mode to the wake mode. Once awake, the target device can communicate with the wireless device according to the second (e.g., more interference resistant) protocol. Upon receiving a second protocol message from a target device, a wireless device can record its location, as well as a corresponding quality value (e.g., power level, level of interference). If a wireless device has not received a second protocol message from the target device as it reaches the HIR activation PIN, the wireless device can transmit a HIR wake message to the target device according to the second protocol. Over time, the wireless device can adjust the HIR activation PIN based on a statistical model using locations and corresponding quality values.

Consequently, as a distance between a wireless device and target device closes, the target device can be awakened by a first protocol message, and be ready (e.g., for on-demand applications) as the wireless device comes within range of the second protocol.

In some embodiments, a second protocol can frequency hop between different bands. In some embodiments, a second protocol can include one or more Bluetooth standards, including but not limited to, Bluetooth Low Energy (BLE).

In some embodiments, a first protocol can include on-off keying (OOK) transmissions.

In some embodiments, a wireless device can travel toward a target device on a route that includes PINs. In some embodiments, a target device can travel toward a wireless device on a route that includes PINs. In some embodiments, a wireless device and target device can travel toward one another on a route that includes PINs. Such PINs can include a HIR activation PIN.

FIGS. 1-0, 1-1, 1-2, 1-3, 1-4 and 1-5 are diagrams of a system 100 and operating environment according to an embodiment. A system 100 can include a wireless device 102 and a target device 104. FIGS. 1-0 to 1-2 show an initialization operation of a system 100 according to an embodiment. FIGS. 1-0 to 1-5 show operations that include communications according to a first wireless protocol (referred to herein as LIR) and a second wireless protocol (referred herein as HIR). A LIR protocol can have lower power consumption and/or lower resistance to interference than an HIR protocol.

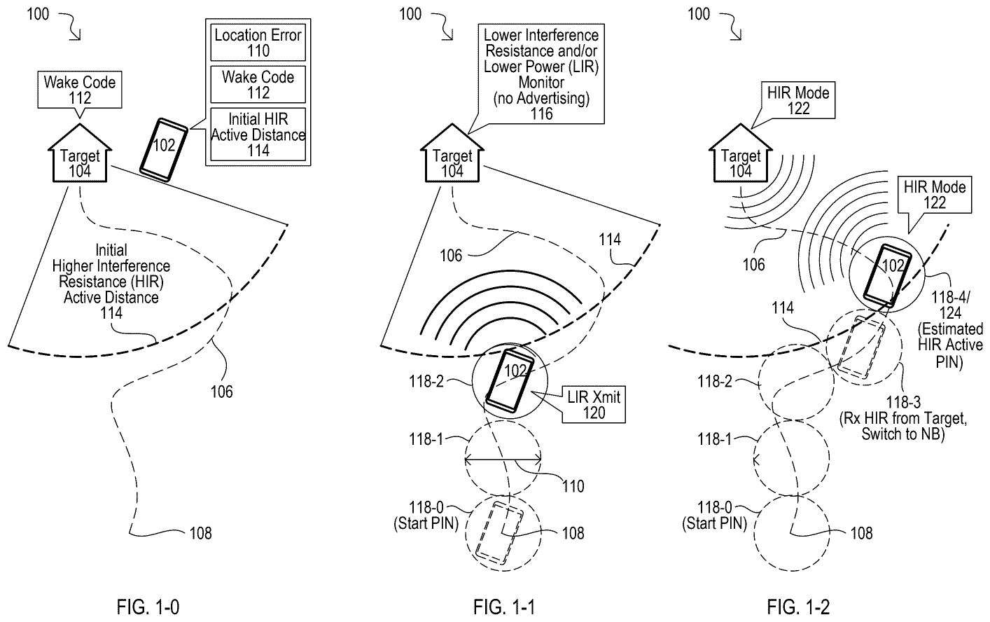

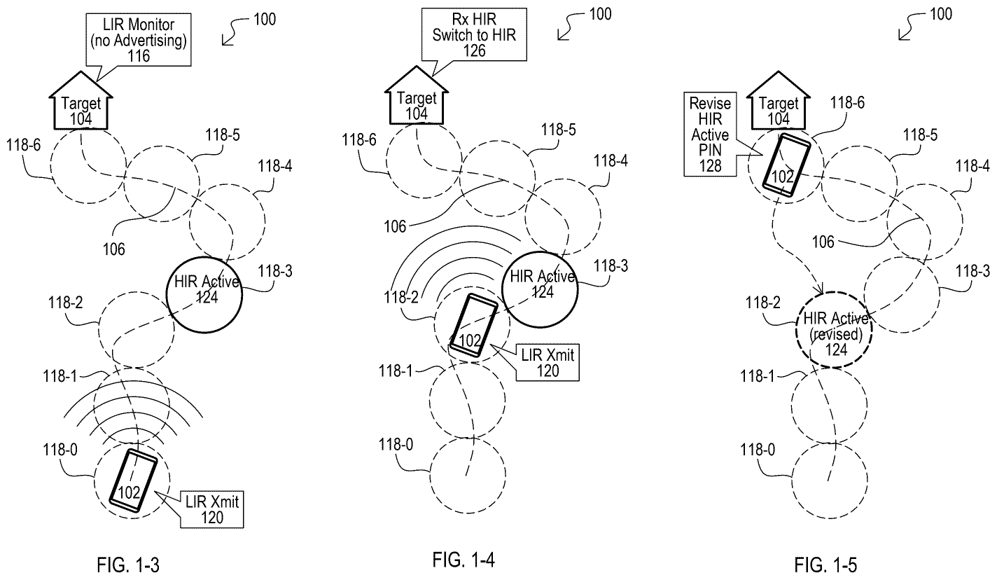

In FIG. 1-0, a wireless device 102 and target device 104 can be in communication with one another. In some embodiments, such a communication can be according to a HIR protocol. Through such communication, a common wake code (or method for generating a wake code) 112 can be established. In addition, an initial HIR active distance 114 can be determined. Such a value can be a first estimated location at which HIR signals from a target device 104 are expected. Such an initial value can be any suitable value, including but not limited to default value based on the HIR protocol (e.g., optimal range, maximum range), a value provided by, or known for, the target device 104, a value generated by the wireless device 102 based on operating conditions, or combinations thereof. Wireless device 102 can have a location error 110. A location error 110 can be based on the fidelity of location circuits of the wireless device 102, as well as operating conditions. In some embodiments, a location error 110 can change over time and/or due to operating conditions.

Referring still to FIG. 1-0 an operating environment can include a route 106, which can be a path between a wireless device 102 and target device 104 during operations of a system 100. In the embodiment shown, during operations a wireless device 102 can arrive at a starting location 108 and follow route 106 to target location. In some embodiments, a route 106 can change over time, or can change according to user.

Referring to FIG. 1-1, at a starting location 108, a wireless device 102 can transmit according to a LIR protocol 120. In some embodiments, wireless device 102 may start first protocol transmission once in proximity to a starting location 108 or based on some other criteria (e.g., distance from a target device location). However, in other embodiments, LIR protocol transmissions can be started in response to any other suitable conditions, including but not limited to, starting an application on the wireless device. Still further, LIR protocol transmissions can be intermittent, or even always on transmissions.

Referring still to FIG. 1-1, as wireless device 102 moves along route 106 it can generate PINs. In the embodiment shown, PINs can have a size and/or spacing based on a location error 110. FIG. 1-1 shows the generation of three PINs 118-0, 118-1, 118-2 as wireless device 102 initially travels along route 106.

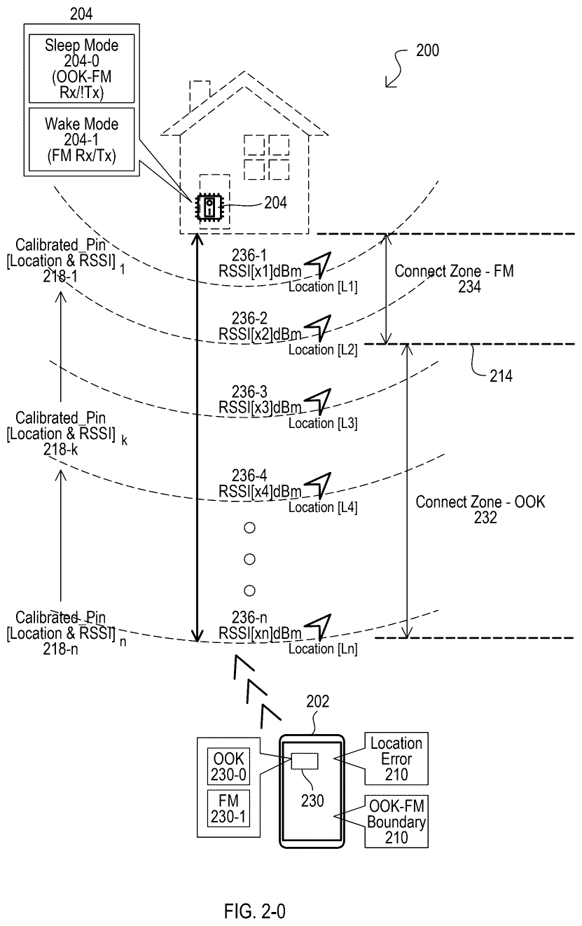

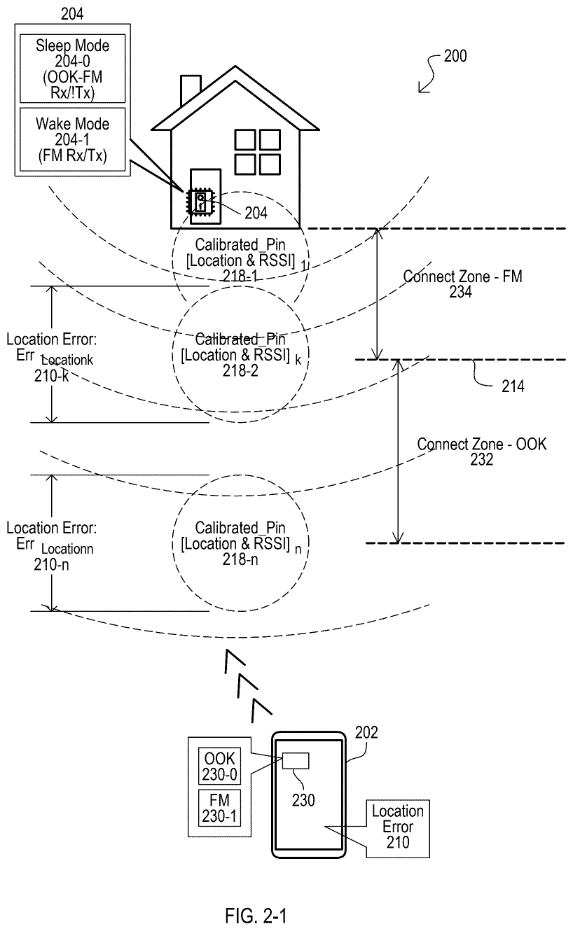

FIG. 1-2 shows a system 100 as a wireless device 102 continues down a route 106, determining more PINs 118-3, 118-4. Due to initial HIR activation distance 114, wireless device 102 has designated PIN 118-4 as an estimated HIR activation PIN 124. That is, wireless device 102 predicts its LIR protocol transmissions will wake up target device 104, and target device 104 will begin transmitting HIR messages which will be received when target device 104 reaches PIN 118-4/124.

However, in the embodiment shown, in response to LIR transmissions from wireless device 102, target device 104 switches to an HIR mode 122 and begins HIR transmissions resulting in wireless device receiving an HIR signal at a PIN 118-3 (i.e., before the estimated HIR activation PIN 1118-4). That is, an initial estimated HIR activation PIN 124 was too far away. As a result, at PIN 118-3, wireless device 102 can switch from the LIR mode to the HIR mode 122, and record the location and where the HIR communication was first received, as well as a quality value for the received HIR signal. Such a quality value can take any suitable form, including but not limited to a power value (e.g., Received Signal Strength Indicator, RSSI), error value (e.g., bit or packet error rate), or measurement of signal interference. Such a quality value can be determined by the wireless device 102 and/or be included in a transmission from target device 104.

A wireless device 102 can continue along route 106 until it reaches target device 104, which can continue to communicate with wireless device 102, including on-demand response. Further, based on the recorded location and quality value at which the HIR signal was received, wireless device 102 can revise the HIR activation PIN. Such a revision can occur over time as more and more location and corresponding quality data are accumulated.

It is understood that a LIR protocol and can be different from an HIR protocol. A LIR protocol can include all or a portion of a message that includes on-off keying (OOK).

It is also understood that in some embodiments, a wireless device 102 can determine that messages according to an LIR protocol do not result in a target device 104 awaking before reaching an HIR PIN. In such cases a target device 104 can be instructed to operate in the HIR mode and forgo communications in the LIR mode, for a set time period, or until instructed to by a wireless device 102.

In this way, as a wireless device travels along a route toward a target device, it can transmit messages according to a first protocol. A wireless device can operate with an initial estimated HIR activation point, at which it will switch to an HIR mode if it has not received an HIR communication from a target device. The estimated HIR activation point can be revised based on the location and quality of an HIR signal received from the target device.

FIG. 1-3 shows a system 100 and operations subsequent to those of FIGS. 1-0 to 1-2. A wireless device 102 has determined PINs 118-0 to 118-6 along an entire route 106 to a target device 104. One of the PINs 118-3 can be currently designated as an HIR activation PIN 124. A wireless device 102 can move along route 106 transmitting first protocol messages 120.

FIG. 1-4 shows a system 100 as wireless device 102 moves further along path 106 in proximity of PINs 118-0 to 118-6. PIN 118-3 can be an estimated HIR activation PIN 124. In the embodiment shown, wireless device 102 transmits LIR protocol messages through PINs 118-0, 118-1, and PIN 118-2. At PIN 118-2, a target device 104 can detect the LIR protocol messages, and switch to an HIR mode 126. Target device 104 can then start transmitting HIR messages to wireless device 102. Wireless device 102 receive an HIR message, record the corresponding location and quality value, and switch to a HIR mode.

FIG. 1-5 shows a system 100 as wireless device 102 reaches target device 104. At this point, and/or as wireless device 102 travels through PIN locations 118-3 to 118-6, a wireless device 102 can revise an HIR activation PIN 128. In the embodiment shown, an HIR activation PIN 124 can be revised from PIN 118-3 to PIN 118-2.

In this way, each time a wireless device travels a route transmitting wake up messages, it can record a location and quality value at which it receives an HIR message, and, if appropriate, update an HIR activation location (e.g., PIN).

FIGS. 2-0 and 2-1 are diagrams showing a system 200 and operations according to another embodiment. A system 200 can include a wireless device 202 and a target device 204. A wireless device 202 can include wireless circuits 230 that can operate in a first protocol mode and second protocol mode. In the embodiment shown, a first protocol mode can include on-off keying (OOK) communication 230-0 over a frequency range. A second protocol mode can include frequency and/or phase modulation (FM) communication 230-1 over one or more frequency ranges. In some embodiments, FM communication 230-1 can include frequency or phase shift keying, including but not limited to communications according to one or more Bluetooth standards, including Bluetooth Low Energy (BLE).

A target device 204 can include sleep mode 204-0 and a wake mode 204-1. In a sleep mode 204-0, a target device 204 can receive/detect OOK or FM messages from a wireless device 204-0, and may not transmit OOK or FM signals. In a wake mode 204-1, a target device 204 can both receive and transmit FM messages.

FIG. 2-0 shows an initial calibration operation. Such an operation can be performed when a target device 204 is first installed at a location. In the embodiment shown, a target device 204 can be a door lock/sensor, but alternate embodiments can include any other suitable device. An initial calibration can include actions executed by wireless device 202. In some embodiments, a wireless device 202 may already include initial calibration functions. In other embodiments, such functions can be installed on the wireless device (e.g., a downloaded application).

Initial calibration operations can include wireless device 202 determining a location error 210. A location error 210 can be the amount by which a wireless device position may be incorrect. As noted herein, a location error 210 can be fixed value, or may vary according to environment or location. A wireless device 202 can placed into an initial position at some distance from a target device 204. Based on a location error 210, wireless device 202 can split a distance between itself and a target device into PINs. In some embodiments, PINs can be tagged geolocated positions.

An initial calibration operation can include establishing an initial OOK-FM boundary 214. Such a boundary can be a default distance, or one based on the operating environment. Locations before the OOK-FM boundary 214 can be considered a connect zone for OOK 232. In an OOK connect zone 232, a wireless device 202 can transmit OOK messages 232 for reception by target device 204. In some embodiments, an OOK message 232 can include a wake code known by target device 204. In an FM connect zone 234, a wireless device 202 can cease OOK communications, and switch to FM communications.

An initial calibration operation can also include a wireless device 202 moving toward a target device 204 on a route. As this occurs, a wireless device 202 can acquire location information with a corresponding quality value 236-n to 236-1. In some embodiments, a quality value can be a BLE RSSI value for the target device 204. Such data can be used to selectively calibrate a new OOK-FM boundary. In some embodiments, such a calibration operation can include a statistical estimation that can be updated with each new addition to a data set. In some embodiments, a statistical estimation can include Kalman Filtering. However, embodiments can include any other suitable statistical model approach, including machine learning.

FIG. 2-1 shows a run-time operation of a system 200 according to an embodiment. A run-time operation can include a wakeup for a target device 204 and a calibration and long term statistical model fit to establish an OOK-FM boundary 214. A wireless device 202 can store calibrated PINs 218-n to 218-1 that can have been established in an initial calibration operation, such as that described for FIG. 2-0. A wireless device 202 can send OOK messages to wake up a target device 204. On further approach toward a target device 204, if a mobile device 202 receives an FM response message from target device 204, the mobile device 202 can switch from OOK communications to FM communications. If no FM response is received from a target device 204 by the time mobile device 202 reaches OOK-FM boundary 214, the mobile device 202 can switch from OOK communications to FM communications.

Once a target device 204 has been awakened, due to an OOK communication or FM communication from a wireless device 202, the wireless device 202 can perform a run-time calibration as it continues to approach the target device. Such a run-time calibration can combine location information, with a corresponding quality value (e.g., RSSI) in a statistical estimation operation to improve overall run-time calibration accuracy. Location information and a quality value can correspond to where an FM communication was received from a target device.

As a wireless device 202 accumulates location and quality value pairs, the wireless device can execute a long term statistical model operation. In some embodiments, such an operation can seek to fit such values to a predetermined distribution (e.g., Bernoulli Distribution). In such a fit, a target device 204 wakeup from OOK communications can occur at a larger distance from a target device 204 than a wakeup from FM communications. A statistical model operation can adjust a calibration parameter to fit the desired statistical distribution. In some embodiments, such a parameter can be based on a transmit power, pervious OOK-FM boundaries, and a total calibration distance (e.g., distance from start of route to target device).

In this way, a target device and wireless device can perform an initial calibration operation to establish a boundary at which a wireless device will switch from first wireless communications to second wireless communications. In run-time operations, as a wireless device approaches a target device broadcasting with first wireless communications to waken the target device. A target device can awaken and begin transmitting according to second wireless communications. A wireless device can record location and power levels of second wireless communications from a target device, and adjust a boundary location by fitting such data to a statistical model.

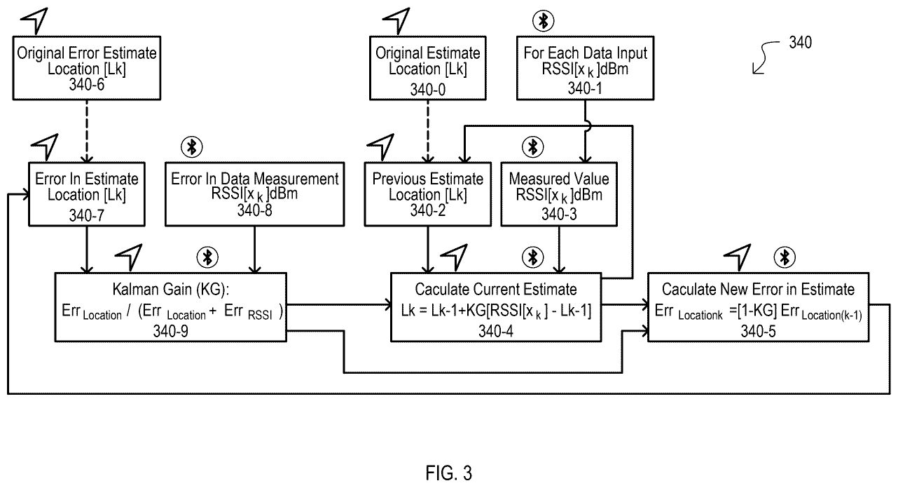

FIG. 3 is a flow diagram of wireless device operations 340 according to an embodiment. In the embodiment shown, operations can be executed by location (e.g., GPS) circuits and FM (e.g., Bluetooth) circuits. Such operations can include establishing an original estimate location 340-0 [Lₖ]. A location [Lₖ] can be an initial location at which a wireless device can switch from transmitting in one mode (e.g., OOK) to another mode (e.g., FM). An original error for the location [Lₖ] can be established 340-6. In some embodiments, such actions 340-0 and 340-6 can be executed by location circuits of a wireless device. An RSSI value for each data input 340-1 can be received. Such a value can represent a signal strength of target device for a location. In some embodiments, such an action can be executed by Bluetooth (BT) circuits.

With each operation (e.g., each time a wireless device moves towards, and wakes a target device), a wireless device can acquire a new location and corresponding RSSI value. Using a previous estimated location Lk 340-2 (which can be provided by values from location circuits), a measured RSSI value 340-3 RSSI[Xₖ] (which can be provided by BT circuits), and a calibration parameter (KG), a current estimated location can be calculated 340-4. In the embodiment shown, an estimated location can be determined according to the relationship:

$$Lk = Lk = Lk - 1 + KG ( RSSI [ {x}_{k} ] - Lk - 1 ,$$

where Lk-1 is a previous estimated location.

After calculating a current estimated location, a new error in estimated location can be calculated 340-5. In the embodiment shown, an error in estimated location can be determined according to the following relationship:

$${Err}_{Locationk} = [ 1 - KG ] {Err}_{Location ( k - 1 )} ,$$

where Err_{Location(k-1)} corresponds to the previous estimated location.

In the embodiment shown, a calibration parameter can be a Kalman Gain (KG), calculated using an error in an estimated location (Err_{Location}) 340-7 (as calculated in 340-5) and an error in data measurement of RSSI (Err_{RSSI}) 340-8. In some embodiments, such an error value can be a difference in RSSI between a current and previous estimated location. In the embodiment shown, KG can be calculated according to the following relationship:

$$KG = {Err}_{Location} / ( {Err}_{Location} + {Err}_{RSSI} ) .$$

In this way, position values from location circuits and signal power level values from wireless circuits can be used to update an estimated location for switching from a first communication mode (e.g., OOK) to a second communication mode (e.g., BT FM) when on route to a sleeping target device.

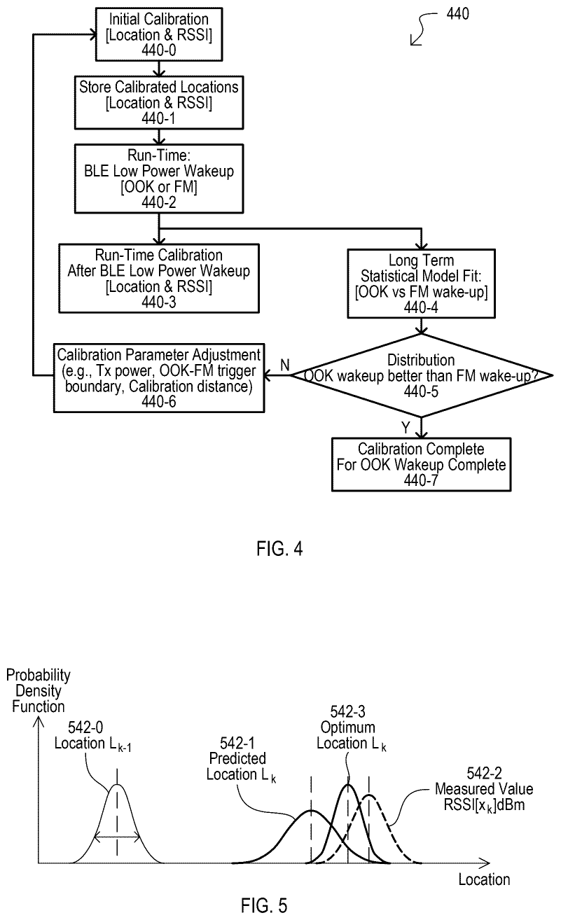

FIG. 4 is a flow diagram of a method 440 of calibrating a boundary location according to an embodiment. A method 440 can include an initial calibration 440-0 that can include a location and RSSI value. Calibrated locations can be stored 440-1. A run-time operation can be executed 440-2. In the embodiment shown, such an action can include, as a distance between a target device and wireless device decreases, a wireless device transmitting according to a first method (e.g., OOK), then switching to a second method (e.g., FM) upon receipt of a message from the target device, or upon reaching the calibrated location.

Once a target device has awakened (e.g., a message has been received in response to OOK or FM transmissions) a run-time calibration operation can be executed 440-3. Such an action can include recording a location and RSSI value corresponding to the run-time operation.

Also following a run-time operation, a method 440 can execute a long term statistical model fit 440-4. Such an operation can seek to differentiate between waking up a target device with a first communication method (e.g., OOK) versus a second communication method (e.g., FM). If a location distribution for a first method is better than that for the second method (Y from 440-5), a method can determine a calibration operation complete 440-7. If a location distribution for a first method is not better than that for the second method (N from 440-5), a method can adjust a calibration parameter 440-6. An adjusted calibration parameter selected to move an initial calibration location to an optimum location (e.g., location that adjusts values to a desired distribution). In some embodiments, a calibration parameter can be adjusted based on any of, a transmit power of the first method (e.g., OOK), a previous location (e.g., OOK-FM trigger boundary) or a calibration distance (e.g., a distance to trigger device at which calibration begins).

FIG. 5 is a graph showing one example of a location adjustment operation according to an embodiment. One or more previous calibration operations can result in a previous location distribution (Lₖ₋₁) 542-0. Based on previous location distribution (Lₖ₋₁), a distribution for a predicted location Lk 542-1 can be generated. In response to an actual measured value (e.g., RSSI) 542-2 corresponding to the predicted location, a distribution for an optimum location Lk can be determined.

In this way, a wireless device can execute calibration operations for determining a transmission boundary for switching from one wireless protocol to another. Over time, such a boundary can be optimized by adjusting calibration values to better fit results to a desired distribution.

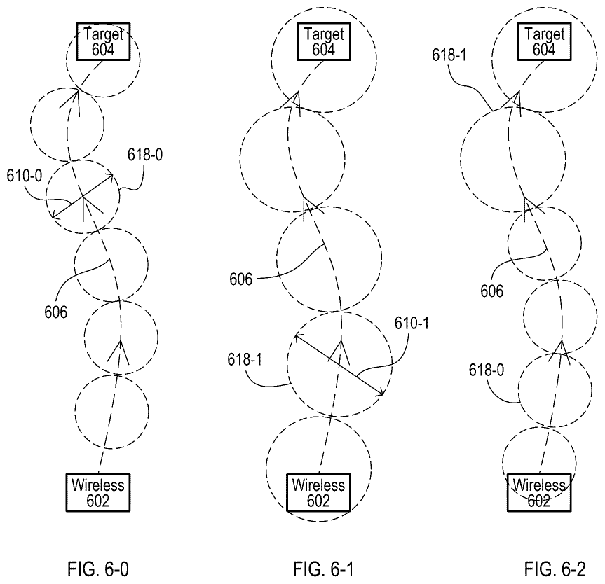

While embodiments can include systems that can operate on a fixed location error, alternate embodiments can operate on location errors that can change over time and/or conditions. FIGS. 6-0, 6-1 and 6-2 are diagrams showing variations in location error according to embodiments. FIGS. 6-0 to 6-2 show a same route 606 between a wireless device 602 and target device 604. FIG. 6-0 shows PINs (one shown as 618-0) based on a location error 610-0. FIG. 6-1 shows how, at a different time, a same route 606 can have PINs (one shown as 618-0) based on a different (e.g., larger) location error 610-1. FIG. 6-2 shows how a route 606 can include PINs of different spacing due to different location error. In FIG. 6-2 some PINs (e.g., 618-0) can be based on one location error while other PINs (e.g., 618-1) can be based on another location error.

In this way, locations along a route can vary according to location error over time and/or conditions.

While embodiments can include methods and systems that include wireless devices that wake target devices, embodiments can also include wireless devices themselves.

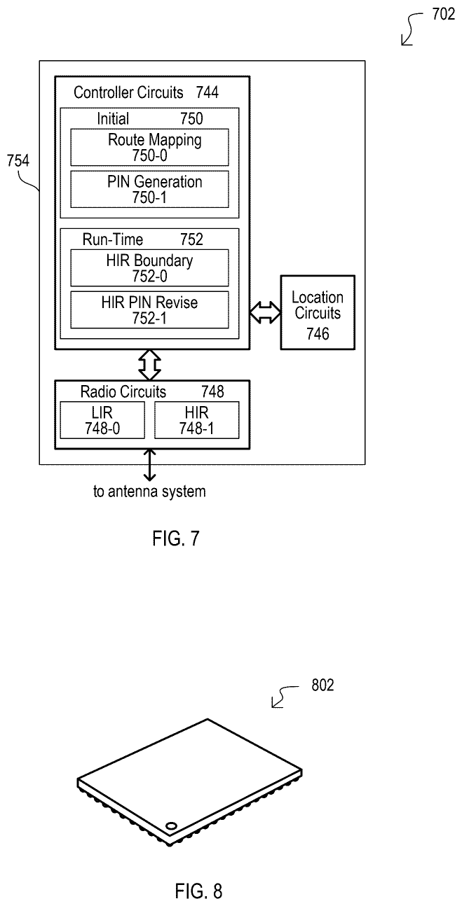

FIG. 7 is a block diagram of a wireless device 702 according to an embodiment. A wireless device 702 can include controller circuits 744, location circuits 746 and radio circuits 748. Controller circuits 744 can include any suitable circuits for executing calibration operations as described herein, including but not limited to, one or more processors, custom logic, programmable logic, and combinations thereof. Controller circuits 744 can perform initial calibration operations 750 as well as run-time calibration operations 752. Initial calibration operations 750-0 can include route mapping 750-0 and PIN generation 750-1. Route mapping 750-0 can include determining a path between a starting location and a location of a target device. PIN generation 750-1 can include determining locations along a route 750-1, and can utilize location values and location error provided by location circuits 746.

Run-time operations 752 can include determining a HIR boundary 752-0 and revising a HIR PIN 752-1. Determining a HIR boundary 752-0 can include determining a location on a route at which a device 702 can switch from a first (i.e., LIR) protocol to a second (i.e., HIR) protocol. Such operations can include any of those described herein or equivalents. HIR PIN revision operations 752-1, can include adjusting a location corresponding to a HIR boundary based on data acquired over time. In some embodiments, such an action can include adjusting first protocol communication operations to better fit a desired statistical distribution as described herein and equivalents.

Location circuits 746 can include circuits suitable for establishing a location of wireless device 702 relative to a target device. In some embodiments, location circuits 746 can be GPS or equivalent circuits. However, alternate embodiments can include other location circuits, including but not limited to range finding circuits operating according to a wireless protocol having a greater range than a HIR protocol or a proprietary protocol employed at a particular site or region. Location circuits 746 can provide a global location (e.g., GPS) and/or a location relative to a target device, as well as an error corresponding to such a location.

Radio circuits 748 can include circuits for communicating according to at least a LIR protocol 748-0 and a HIR protocol 748-1. A LIR protocol 748-0 can transmit a message that can wake a target device, and in some embodiments, can result in less power consumption for a target device and/or less resistance to interference than a HIR protocol. Radio circuits 748 can be connected to one or more antenna systems suitable for transmitting according to a LIR protocol 748-0 and transmitting and receiving according to a HIR protocol 748-1. In some embodiments, a LIR protocol 748-0 can differ from a HIR protocol 748-1 by any of: consuming less power, being less resistant to interference, or transmitting with OOK, while a HIR protocol 748-1 can use FM.

In some embodiments, controller circuits 744, location circuits 746 and radio circuits 748 can be formed with a same substrate 754.

In this way, a wireless device can execute initial calibration operations to establish a HIR boundary, and then optimize such a boundary in subsequent run-time operations.

While embodiments can include wireless devices with various interconnected components, embodiments can also include unitary wireless devices which can execute initial and run-time calibration operations as described herein and equivalents. In some embodiments, such unitary devices can be advantageously compact single integrated circuits (i.e., chips). FIG. 8 shows a packaged IC device 802 which can execute calibrated wake up operations with a target device according to embodiments described herein. However, a wireless device according to embodiments can include any other suitable integrated circuit packaging type, as well as direct bonding of a device chip onto a circuit board or substrate.

In this way, a wireless device can include an integrated circuit device.

While wireless device embodiments can include integrated circuit device, other embodiments can take other forms, such as smartphones or other portable computing devices, including but not limited to tablet computing devices, laptop computers, or wearable computing devices.

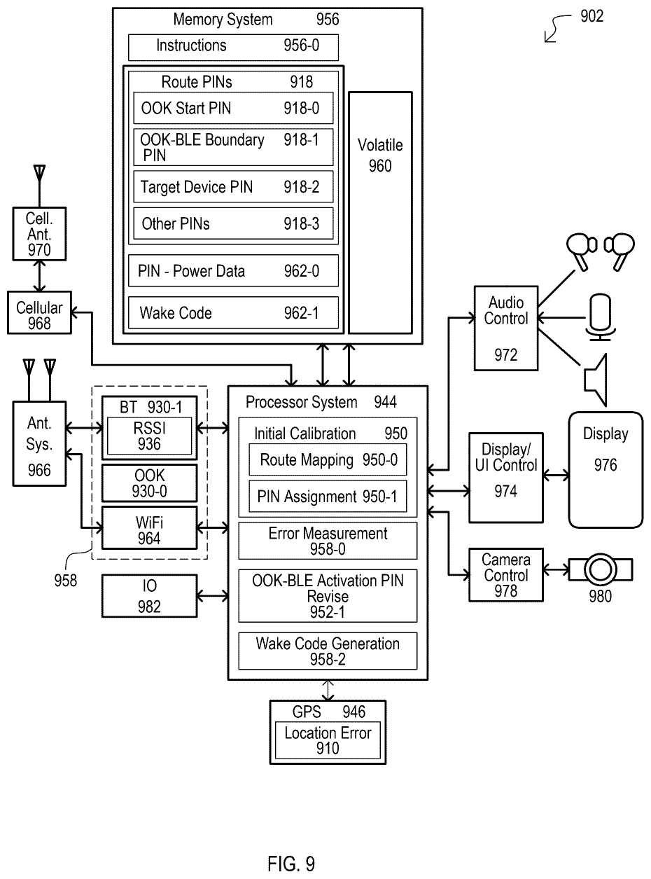

FIG. 9 is a block diagram of a wireless device 902 according to another embodiment. A wireless device 902 can include a processor system 944, a memory system 956, wireless circuits 958, location circuits 946, cellular circuits 962, audio control circuits 972, input/output (IO) circuits 982, display/user interface (UI) control circuits 974, and camera control circuits 978.

A processor system 944 can include one or more processors that can execute instructions 956-0 stored in memory system 956 to provide various functions described herein, as well as other functions suitable to the type of device (cell phone communication, execution of other applications etc.). Executed instructions 972-0 can provide functions including but not limited to: initial calibration 950, error measurement 958-0, location estimate 958-1, location revision 952-1, and wake code generation 958-2. Initial calibration 950 can include route mapping 950-0 and PIN assignment 950-1. Route mapping 950-0 can establish a route between a wireless device 902 and a target device as described herein and equivalents. PIN assignment 950-1 can include establishing PINs along a route, and assigning to some of the PINs specific roles.

An error measurement operation 958-0 can determine an error between an estimated location and conditions at an actual location at which a HIR (e.g., BLE) transmission is received from a target device. Such error can be based on any suitable measurements, including but not limited to RSSI. A location revision operation 958-1 can selectively update a location for an OOK-FM (e.g., BLE) boundary, based on newly received input values (e.g., RSSI), as well as previous location values. In some embodiments, such an operation can include a statistical model fit, as described herein and equivalents. A wake code generation operation 958-2 can generate a wake code for transmission (e.g., in an OOK message). In some embodiments, a wake code can be generated with a target device. Further, wake codes can be static (e.g., the same for each calibration operation), or can be dynamic (change between calibration operations).

A memory system 956 can include nonvolatile memory and, in some embodiments, volatile memory 960. A memory system 956 store various values for executing initial and run-time calibration operations as described herein or equivalents. Stored values can include, but are not limited to: instructions 956-0 for execution by processor system 944, route PINs 918, PIN-power data 962-0 and a wake code 962-1. Route PINs 918 can include locations along a route, as a well as assigned valued for particular PINs. Route PINs 918 can include an OOK start PIN 918-0, a OOK-BLE boundary PIN 918-1, target device PIN 918-2 and other PINs 918-3. An OOK start PIN 918-0 can be a location at which a wireless device can begin to transmit messages according to a first protocol (e.g., OOK). An OOK-BLE boundary PIN 918-1 can be a location at which a wireless device can switch from a LIR protocol (e.g., OOK) to a HIR protocol (e.g., BLE), as described herein or equivalents. A target device PIN 918-2 can indicate a location of a target device. Other PINs 918-3 can include other PINs along a route.

Wireless circuits 958 can include BT circuits 930-1, OOK circuits 930-0 and WiFi circuits 964. BT circuits 930-1 can be compatible with one or more BT standards, and in the embodiment shown, can be compatible with BLE. BT circuits can include RSSI circuits 936 for determining an RSSI of a received signal, such a BLE transmission from a target device. OOK circuits 930-0 can transmit messages for waking a target device. Such OOK messages for a target device can include a wake code 962-1. WiFi circuits 964 can be compatible with one or more IEEE 80.211 wireless standards. Wireless circuits 958 can be connected to a compatible antenna system 966.

Location circuits 946 can determine a location of a wireless device 902, and in some embodiments can include GPS circuits. Audio control circuits 972 can provide audio functions for a wireless device 902. Display UI control circuit 974 can control a display 976 of a wireless device 902, which an also serve as a user input (e.g., a touchscreen). A camera control circuit 978 can control a camera system 980.

Cellular circuits 968 can provide communication functions according to one or more cellular standards and can be connected to a cellular antenna system 970. IO circuits 982 can include any suitable IO circuits that can enable wireless device 902 to communicate with other devices. IO circuits 982 can be wired or wireless. In some embodiments, IO circuits 982 can include one or more serial interfaces.

In some embodiments, a processor system 944, memory system 956, and wireless circuits 958 can be formed by a system-on-chip (SoC) type device. In some embodiments, a wireless device 902 can be a smart phone.

In this way, a wireless device can include wireless circuits capable of OOK and BLE transmissions, along with processor circuits for executing initial and run-time calibration operations for optimizing the waking of a target device with OOK messages to enable on-demand operations according to BLE messages.

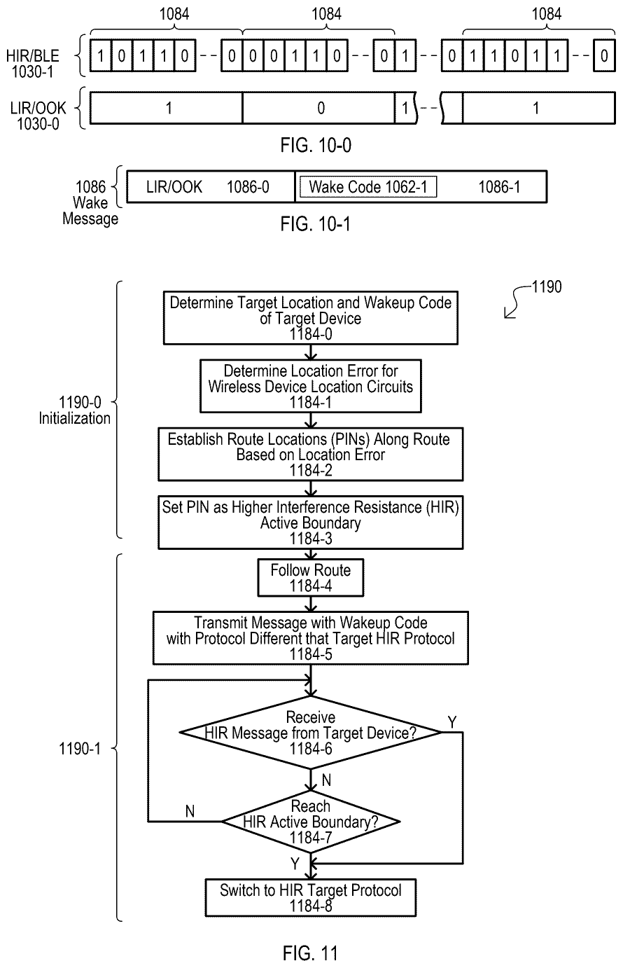

FIG. 10-0 is a diagram showing different protocol in bit rates according to an embodiment. In the embodiment shown, during transmissions, over a same time period 1084, while a LIR (i.e., wake) protocol 1030-0 transmits one bit, a HIR (e.g., active) protocol 1030-1 can transmit multiple bits. In some embodiments, an HIR protocol 1030-1 can include frequency modulation, including but not limited to frequency shift keying. In some embodiments, a LIR protocol 1030-0 can include, for one bit, a sequence of same bit values as in the HIR protocol. Such longer timer period values can represent OOK operations.

In this way, a first protocol, intended to wake a sleeping target device, can include on-off keying at a slower bit rate than wake protocol used by a target device once it has awakened.

FIG. 10-1 is a block diagram of wake message 1086 according to an embodiment. A message 1086 can include an OOK portion 1086-0, followed by a payload portion 1086-1. An OOK portion 1086-0 can include on-off keying as described herein and equivalents. In some embodiments, a payload portion 1086-1 can include data transmitted at a faster bit rate than the OOK portion 1086-0. However, alternate embodiments can include bit rates that are the same as an OOK portion 1086-0. A payload portion 1086-1 can include a wake code 1062-1 that can identify a sending device as a valid device to the target device.

In this way, a wake message for a target device can include a OOK portion and a payload portion that contains a wake code for the target device.

While the systems and devices described herein show various methods, additional methods will now be described with reference to flow diagrams. Such methods can be executed by circuits of devices and/or systems described herein.

FIG. 11 is a flow diagram of a method 1190 according to an embodiment. A method can be executed by a wireless device. A method 1190 can include initial operations 1190-0 and run-time operations 1190-1. An initial operation 1190-0 can include determining a target location and wake up code for a target device 1184-0. Such an action can include an initial setup operation with a target device and/or another computing system (e.g., remote server) associated with the target device. A location error can be determined for a wireless device 1184-1. Such an action can include location circuits of the wireless device providing an error value.

A method 1190 can include establishing PINs along a route based on location error 1184-2. Such an action can include storing PIN locations along a route, where a spacing between PINs is related to a location error. One of the PINs can be set as a HIR active boundary 1184-3. Such an action can include assigning one of the PINs as the point at which a wireless device can switch from a OOK (or other) mode to a FM mode if it has not received a message from the target device. As understood from embodiments herein, such a HIR active boundary can be adjusted over time.

A run-time operation 1190-1 can include following a route 1184-4. Such an action can include a wireless device following a route toward a target device, or a target device following a route toward a wireless device, or a combination thereof. A message can be transmitted with a wake up code according to a protocol that is different from that used by a target device when awake 1184-5. Such an action can include a wireless device transmitting a message according to LIR, OOK or any other suitable methods. If a HIR message is received from a target device (Y from 1184-6), a wireless device can switch to a HIR target protocol 1184-8. If a HIR message is not received from a target device (N from 1184-6), a determination can be made as to whether the HIR active boundary has been reached 1184-7. If such a boundary has been reached (Y from 1184-7) wireless device can switch to a HIR target protocol 1184-8. If an HIR active boundary has not been reached (N from 1184-7), a method can continue to check for a HIR message from a target device 1184-6.

In this way, a method can include an initialization portion that establishes a wake up code with a target device, and a run-time portion that transmits the wake up code to enable the target device to awake from a sleep state and start transmissions according to a protocol having higher resistance to interference and/or higher power consumption.

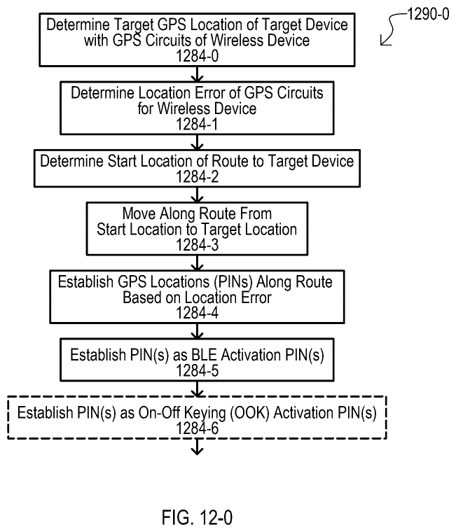

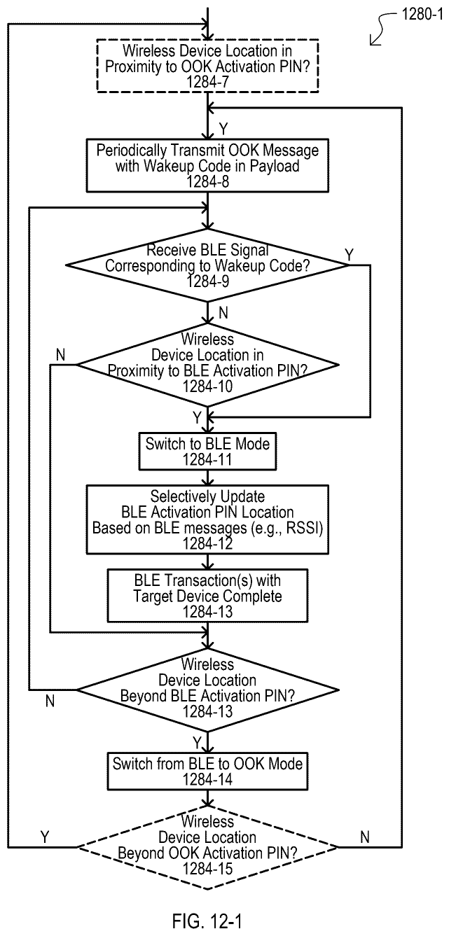

FIG. 12-0 is a flow diagram of an initialization method 1290-0 according to another embodiment. A method 1290-0 can be executed by a wireless device. A method 1290-0 can include determining a target GPS location of a target device with GPS circuits of a wireless device 1284-0. A location error for GPS circuits can be determined 1284-1. A start location of a route to a target device can be determined 1284-2. Such an action can include user indicating a start location (e.g., through use of a corresponding application) and/or such a location being established based on a range of an OOK protocol.

A method 1290-0 can include moving along a route from a start location to a target location 1284-3. While moving along the route, GPS locations (e.g., PINs) can be established based on a location error 1284-4. One or more PINs can be established as BLE activation PINs 1284-5. A BLE activation PIN can be a PIN at which a wireless device can switch from OOK transmissions to BLE transmissions in the event communications from a target device have not been received. Optionally, one or more PINs can be established as OOK activation PINs 1284-6. An OOK activation PIN can be a PIN at which a wireless device can start transmitting OOK transmissions.

In this way, a method can include determining a GPS location of a target device, as well as locations on a route to a target device, one of which can be a BLE activation location.

FIG. 12-1 is a flow diagram of a run-time method 1290-1 according to an embodiment. A method 1290-1 can be executed by a wireless device along with an initialization method, like that shown in FIG. 12-0. Optionally, a method 1290-1 can include determining that a wireless device is within proximity to a OOK activation PIN 1284-7. A method can periodically transmit OOK messages with a wakeup code in a payload 1284-8. Such an action can include any of those described herein or equivalents.

A method 1290-1 can include determining if a BLE signal corresponding to a wake up signal is received 1284-9. If such a signal is not received (N from 1284-), a method can determine if a wireless device is in proximity to a BLE activation PIN 1284-10. If a BLE signal corresponding to a wake up code is received (Y from 1284-9) or a wireless device is in proximity to a BLE activation PIN (Y from 1284-10), a method can switch to a BLE mode 1284-11. Such an action can include proceeding with communications with a now awake target device with BLE communications.

Once in a BLE mode, a method can selectively update a BLE activation PIN location based on BLE messages 1284-12. Such an action can include any of those described herein, including methods using statistical models, and basing such evaluations on an RSSI or other features of received BLE messages.

Once BLE transactions with a target device are complete 1294-13 or a wireless device location is no longer in proximity to a BLE activation PIN (N from 1284-10), a method can determine if a wireless device location is now beyond a BLE activation PIN 1284-13. If a wireless device is not beyond a BLE activation PIN (N from 1284-13), a method can return to determining if a BLE signal with a wake up code is received (1284-9). If a wireless device is beyond a BLE activation PIN (Y from 1284-13), a method can switch from a BLE mode back to an OOK mode 1284-14.

Optionally, a method 1290-1 can determine if a wireless device has moved beyond an OOK activation PIN 1284-15. If a device is determined not to be beyond an OOK activation PIN (N from 1284-15), a method can return to transmitting OOK messages 1284-8. If a device is determined to be beyond an OOK activation PIN (Y from 1284-15), a method can optionally cease OOK transmissions and return to 1284-7.

In this way, a method can include periodically transmit OOK messages with a wake up code. Once a wireless device receives BLE message from a target device, or a wireless device is within range of a BLE activation PIN, the wireless device can switch to a BLE mode.

While embodiments can include wireless devices that transmit messages to wakeup a target device, embodiments can also include corresponding target devices.

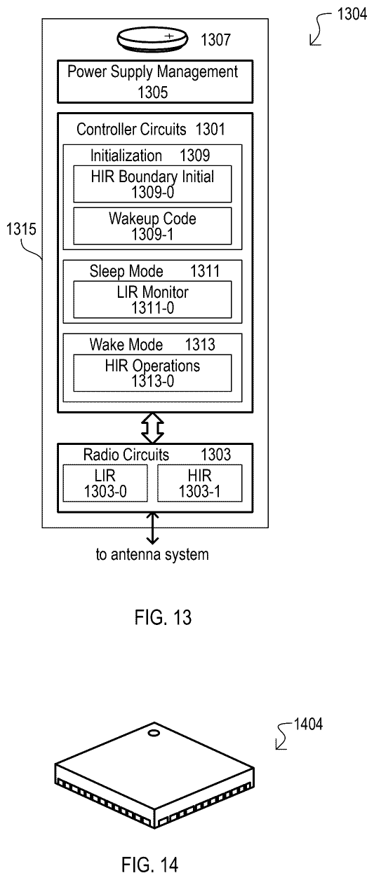

FIG. 13 is a block diagram of a target device 1304 according to an embodiment. A target device 1304 can include controller circuits 1301, radio circuits 1303, and power supply management circuits 1305. In some embodiments, a target device 1304 can include a battery 1307. Controller circuits 1301 can include circuits for executing operations of a target device as described herein or equivalents. Controller circuits 1301 can execute initialization operations 1309, sleep mode operations 1311 and wake mode operations 1313.

Initialization operations 1309 can include determining an initial HIR boundary 1309-0 and determining a wakeup code 1390-1. An initial HIR boundary determination 1309-0 can operate in conjunction with a wireless device to establish an initial HIR activation boundary, according to embodiments described herein or equivalents. However, as noted herein, a wireless device can determine such a value by accessing other devices (e.g., remote server with target device information). Wakeup code generation 1309-1 can include deriving a wakeup code. Such an action can include communicating with a wireless device to establish a wakeup code for the target device and/or a method (e.g., algorithm) for generating a wake up code.

In a sleep mode 1311, a target device can monitor for LIR messages 1311-0, while not transmitting HIR signals or LIR signals. In a wake mode 131-0 a target device 1304 can transmit and receive according to a HIR protocol.

Radio circuits 1303 can include LIR circuits 1303-0 and HIR circuits 1303-1. LIR circuits 1303-0 can at least detect signals that trigger a wakeup operation. In some embodiments, LIR circuits 1303-0 can detect OOK signaling. HIR circuits 1301-1 can transmit according to a HIR protocol that can be used when target device 1304 is awake. In some embodiments, a HIR protocol can include BLE.

Power supply management circuits 1305 can be connected to a battery 1307, and can control power distribution in a target device 1304. Power supply management circuits 1305 can include a sleep mode and wake mode.

In some embodiments, a target device 1304 can be a unitary device, with all components included in a same device structure 1304. A device structure 1304 can be that of an Internet-of-Things (IoT) type device.

In this way, a target device can include sleep mode operations that conserve power while monitoring for LIR signaling, and a wake mode where communications can occur according to a HIR protocol.

While embodiments can include target devices with various interconnected components, embodiments can also include unitary target devices which can execute sleep and wake modes as described herein and equivalents. In some embodiments, such unitary devices can be advantageously compact single integrated circuits. FIG. 14 shows a packaged IC device 1404 which can execute LIR monitoring and wake up operations with a wireless device according to embodiments described herein.

In this way, a target device can include an integrated circuit device.

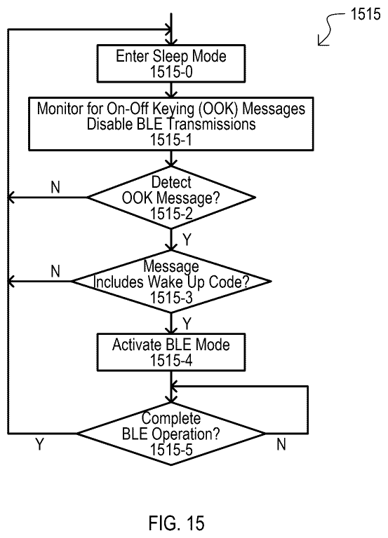

FIG. 15 is a flow diagram of a method 1515 according to another embodiment. A method 1515 can include entering a sleep mode 1515-0. In a sleep mode, a method can monitor for OOK messages and disable BLE transmissions 1515-1. If an OOK message is detected (Y from 1515-2), a method can determine if the message includes a wake up code 1515-3. If a wake up code is included (Y from 1515-3), a method can activate a BLE mode 1515-4. Once BLE operations are complete (Y from 1515-5) a method can return to a sleep mode 1515-0.

In this way, a method can include entering a sleep mode that monitors for OOK signaling while BLE operations are disabled. When an OOK message is detected that includes a wake code, a BLE mode can be activated.

FIGS. 16-0 and 16-1 are diagrams showing a system 1617 according to another embodiment. A system 1617 can include a set of sensors 1604, each of which can take the form of a target device as described herein or equivalents. In some embodiments, sensors 1604 can be tire pressure monitoring system (TPMS) and other sensors for an automobile.

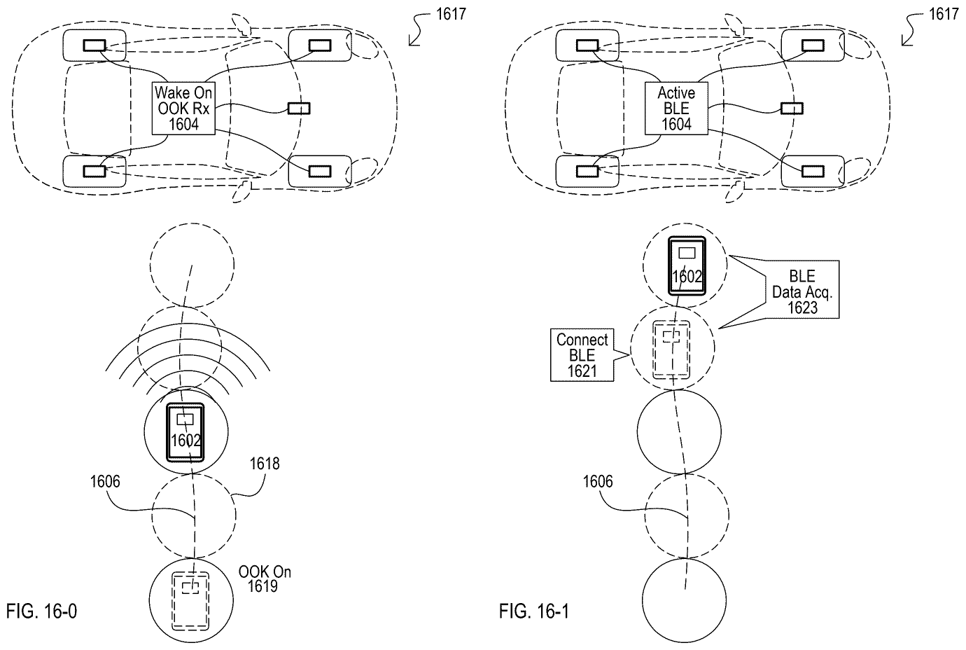

Referring to FIG. 16-0, sensors 1604 can be in a sleep mode that monitors for OOK messages. A wireless device 1602 can travel along a route 1606 while transmitting OOK messages with wake codes for sensors 1604. A route 1606 can include various PINs (one shown as 1618) as described herein and equivalents.

Referring to FIG. 16-1, in response to OOK messages from wireless device 1602, sensors 1604 can awaken and go through processes necessary to activate BLE circuits. Consequently, sensors 1604 can transmit messages enabling wireless device to connect 1621. A wireless device 1602 can then gather on-demand data 1623 through BLE communications.

In this way, a group of sensors on a device can be in a sleep mode, and then awakened with OOK signaling by a wireless device traveling on a route. When a wireless device is in BLE range, sensors can provide on-demand data.

FIGS. 17-0 to 17-1 show a system 1717 like that of FIGS. 16-0/1, and like items are referred with the same reference characters but with the leading digits being a “17” instead of a “16”. A system 1717 shows an arrangement in which sensors 1704 can move toward a wireless device to provide on-demand response.

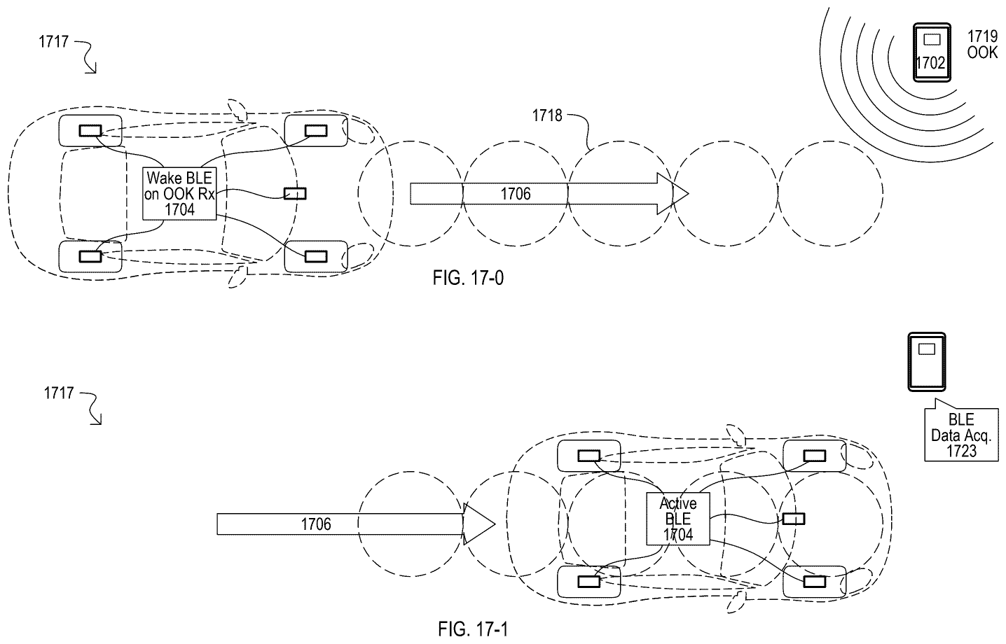

Referring to FIG. 17-0, sensors 1704 can be in a sleep mode that monitors for OOK messages. Sensors 1704 can travel along a route 1706 while a wireless device 1702 transmits OOK messages with wake codes. A route 1706 can include various PINs (one shown as 1718), including a BLE activation PIN.

Referring to FIG. 17-1, in response to receiving OOK messages from wireless device 1702, sensors 1704 can awaken and activate BLE circuits. Consequently, sensors 1704 can transmit messages enabling wireless device to connect and gather on-demand data 1723 through BLE communications.

In this way, a group of sensors on a device can be in a sleep mode, and then awakened with OOK signaling as they travel toward a wireless device. When sensors are in range, they can provide on-demand data to a wireless device.

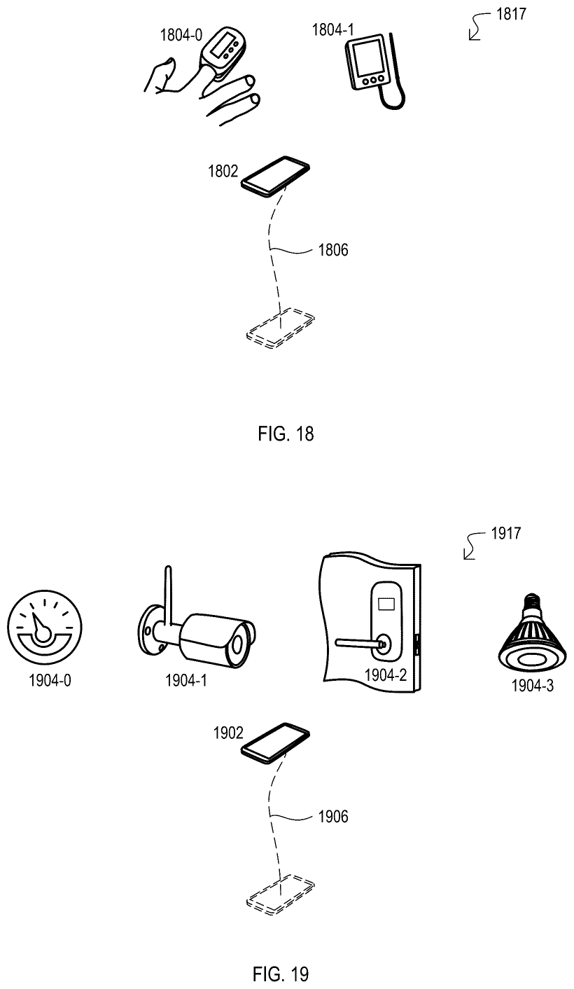

Referring to FIG. 18 medical systems 1817 according to an embodiment is shown in a diagram. A system 1817 can include medical devices 1804-0, 1804-1 that can operate as target devices, as described herein and equivalents. Medical devices 1804-0/1 can include a sleep mode, in which they can monitor for OOK or other messages from a wireless device 1902. A wireless device 1902 can transmit OOK messages along a route 1906, which can include an OOK-FM boundary or PIN as described herein or equivalents. Upon receiving such OOK or other messages, medical devices 1804-0/1 can transition from a sleep mode to a wake mode, and be ready to transmit data according to an HIR protocol (e.g., FM including BLE). A wireless device can adjust OOK transmissions to optimize an OOK-FM boundary as described herein and equivalents.

Referring to FIG. 19 various other systems 1917 according to embodiments are shown in a diagram. System 1917 can include industrial devices 1904-0 (e.g., gauges), security devices 1904-1 (e.g., cameras, alarms, sensors), and home automation devices 1904-2/3 (e.g., locks, lighting, HVAC control). A route can exist between devices 1904-0 to -3 and a wireless device 1902. Devices 1904-0 to -3 can operate as target devices, as described herein and equivalents. Wireless device 1902 can operate as a wireless device as described herein.

In this way, wireless devices that operate with target devices as described herein, can enjoy a wide variety of applications.

Embodiments can include methods, devices and systems that include, by operation of location circuits of a wireless device, determining a location of the wireless device and location error for the location. By operation of controller circuits of the wireless device, determining a plurality of PINs for a route between the wireless device and a target location, a spacing between the PINs based on the location error. The PINs can include a HIR activation PIN. By operation of wireless circuits, a wake message can be transmitted having at least a wakeup code according to a first wireless protocol. In response to receiving an awake message according to a second wireless protocol, storing a location and quality value for the awake message. An awake message can correspond to the wakeup code. In response to being within a predetermined proximity of the HIR activation PIN without having received the awake message, transmitting a HIR wake message according to the second wireless protocol; and, in response to acquiring a plurality of stored location values and corresponding quality values over time, selectively changing the HIR activation PIN; wherein the first wireless protocol can consume less power or be less resistant to interference than the second wireless protocol.

Embodiments can include methods, devices and systems having location circuits configured to determine a location of the device and a location error. Wireless circuits can be configured to operate according to a first wireless protocol that includes transmitting an awake message with a wake code and a second wireless protocol. Controller circuits can be configured to determine a plurality of PINs for a route to a target location, a spacing between the PINs being based on the location error. The PINs can include a HIR activation PIN. In response to receiving an awake message according to a second wireless protocol, a location and quality value for the awake message can be stored. An awake message can correspond to a wakeup code. Controller circuits can also be configured to, in response to being within a predetermined proximity of an HIR activation PIN without having received the awake message, transmitting a HIR wake message according to a second wireless protocol. Further, in response to acquiring a plurality of stored location values and corresponding quality values over time, the HIR activation PIN can be selectively changed. The first wireless protocol can consume less power or be less resistant to interference than the second wireless protocol.

Embodiments can include methods, devices and systems having a wireless device that includes location circuits configured to determine a location of the device and a location error. Wireless circuits can be configured to operate according to a second wireless protocol and a first wireless protocol. Controller circuits can be configured to determine a plurality of PINs for a route to a target location, a spacing between the PINs based on a location error. PINs can include a HIR activation PIN. Controller circuits can also be configured to, in response to receiving an awake message according to a HIR wireless protocol, a location and quality value for the awake message can be stored. An awake message corresponding to a wakeup code. Controller circuits can also, in response to being within a predetermined proximity of the HIR activation PIN without having received the awake message, transmit a HIR wake message according to the second wireless protocol, and, in response to acquiring a plurality of stored location values and corresponding quality values over time, selectively change the HIR activation PIN. An antenna system can be coupled to the wireless device that is compatible at least the NB and first wireless protocols. The first wireless protocol can consume less power or be less resistant to interference than the second wireless protocol.

Methods, devices and systems according to embodiments can include a determining of a location of the wireless device including determining a Global Positioning System location.

Methods, devices and systems according to embodiments can include a quality value including a signal strength value.

Methods, devices and systems according to embodiments can include a quality value including a measurement of signal interference.

Methods, devices and systems according to embodiments can include selectively changing a HIR activation PIN including fitting at least the plurality of stored location and quality values for received HIR wake messages to a statistical model.

Methods, devices and systems according to embodiments can include a wireless device moving towards a target location essentially along a route.

Methods, devices and systems according to embodiments can include, by operation of a target device at the target location, monitoring the for the wake message while not making transmissions according to the first wireless protocol and HIR wireless protocol. In response to receiving a wake message with a wakeup code, activating HIR circuits and initiating communications according to the second wireless protocol.

Methods, devices and systems according to embodiments can include location circuits compatible with at least a Global Positioning System.

Methods, devices and systems according to embodiments can include the first wireless protocol comprising OOK.

Methods, devices and systems according to embodiments can include a second wireless protocol comprising at least one Bluetooth Standard, and a quality value can be a received signal strength indication and/or a measurement of signal interference.

Methods, devices and systems according to embodiments can include controller circuits configured to fit at least the plurality of stored location and quality values for received HIR wake messages to a statistical model.

Methods, devices and systems according to embodiments can include controller circuits configured to determine an estimated HIR activation PIN with at least the stored location and quality values, and upon receiving an awake message, determining an error between the estimated HIR activation PIN and the location at which the awake message was received, and selectively changing the HIR activation PIN in response to the error.

Methods, devices and systems according to embodiments can include a target device configured to operate according to the second wireless protocol and first wireless protocol, transition from a sleep mode to a second protocol active mode in response to receiving the awake message, or receiving the HIR wake message. A sleep mode can include not transmitting according to the first and second wireless protocols and monitoring for the awake message and HIR wake message.

Methods, devices and systems according to embodiments can include a target device having a battery.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of location circuits of a wireless device, determining a location of the wireless device and location error for the location;
by operation of controller circuits of the wireless device, determining a route between the wireless device and a target location that includes at least one higher interference resistance (HIR) location coordinate (PIN) based on at least the location error;
by operation of wireless circuits, transmitting a wake message having at least a wakeup code according to a first wireless protocol;
in response to receiving an awake message according to a second wireless protocol, storing a location and quality value for the awake message, the awake message corresponding to the wakeup code;
in response to being within a predetermined proximity of the HIR activation PIN without having received the awake message, transmitting a HIR wake message according to the second wireless protocol; and
in response to acquiring a plurality of stored location values and corresponding quality values over time, selectively changing the HIR activation PIN; wherein
the first wireless protocol consumes less power or is less resistant to interference than the second wireless protocol.

2. The method of claim 1, wherein determining the location of the wireless device includes determining a Global Positioning System location.

3. The method of claim 1, wherein the quality value comprises a signal strength value.

4. The method of claim 1, wherein the quality value comprises a measurement of signal interference.

5. The method of claim 1, wherein:
the second wireless protocol comprises at least one Bluetooth Standard; and
the quality value includes a Receive Signal Strength Indicator value.

6. The method of claim 1, wherein the first wireless protocol comprises on-off keying.

7. The method of claim 1, wherein selectively changing the HIR activation PIN includes fitting at least the plurality of stored location and quality values for received HIR wake messages to a statistical model.

8. The method of claim 1, further including the wireless device moving towards the target location essentially along the route.

9. The method of claim 1, further including:
by operation of a target device at the target location
monitoring for the wake message while not making transmissions according to the first wireless protocol and second wireless protocol, and
in response to receiving the wake message with the wakeup code, activating HIR circuits and initiating communications according to the second wireless protocol.

10. A device, comprising:
location circuits configured to determine a location of the device and a location error;
wireless circuits configured to operate according to
a first wireless protocol that includes transmitting an awake message with a wake code, and a second wireless protocol; and
controller circuits configured to
determine at least a higher interference resistance (HIR) activation location coordinate (PIN) on a route to a target location, at least the HIR PIN being based on the location error;
in response to receiving an awake message according to the second wireless protocol, storing a location and quality value for the awake message, the awake message corresponding to the wake code;
in response to being within a predetermined proximity of the HIR activation PIN without having received the awake message, transmitting a HIR wake message according to the second wireless protocol, and
in response to acquiring a plurality of stored location values and corresponding quality values over time, selectively changing the HIR activation PIN; wherein
the first wireless protocol consumes less power or is less resistant to interference than the second wireless protocol.

11. The device of claim 10, wherein the location circuits are compatible with at least a Global Positioning System.

12. The device of claim 10, wherein the first wireless protocol comprises on-off keying.

13. The device of claim 10, wherein:
the second wireless protocol comprises at least one Bluetooth Standard; and
the quality value is selected from the group of: a received signal strength indication and a measurement of signal interference.

14. The device of claim 10, wherein the controller circuits are further configured to fit at least the plurality of stored location and quality values for received HIR wake messages to a statistical model.

15. The method of claim 1, wherein:
the controller circuits are further configured to
determine an estimated HIR activation PIN with at least the stored location and quality values,
upon receiving an awake message, determining an error between the estimated HIR activation PIN and the location at which the awake message was received, and
selectively changing the HIR activation PIN in response to the error.

16. A system, comprising:
a wireless device that includes
location circuits configured to determine a location of the device and a location error,
wireless circuits configured to operate according to a second wireless protocol and a first wireless protocol,
controller circuits configured to
determine at least a higher interference resistance (HIR) location coordinate (PIN) on a route to a target location based on at least the location error,
in response to receiving an awake message according to the second wireless protocol, store a location and quality value for the awake message, the awake message corresponding to a wakeup code;
in response to being within a predetermined proximity of the HIR activation PIN without having received the awake message, transmit a HIR wake message according to the second wireless protocol, and
in response to acquiring a plurality of stored location values and corresponding quality values over time, selectively change the HIR activation PIN; and
an antenna system coupled to the wireless device that is compatible at least the second and first wireless protocols; wherein
the first wireless protocol consumes less power or is less resistant to interference than the second wireless protocol.

17. The system of claim 16, wherein:
the location circuits are compatible with at least one Global Positioning system; and
the second wireless protocol includes at least one Bluetooth Standard.

18. The system of claim 16, wherein the first wireless protocol comprises on-off keying.

19. The system of claim 16, further including:
a target device configured to
operate according to the second and first wireless protocols,
transition from a sleep mode to a second protocol active mode in response to receiving the awake message, or in response to receiving the HIR wake message; wherein
the sleep mode includes not transmitting according to the first and second wireless protocols and monitoring for the awake message and HIR wake message.

20. The system of claim 19, wherein the target device further includes a battery.
